(19) United States
(12) Patent Application Publication
(10) Pub. No.: US 2020/0394081 A1
(43) Pub. Date: Dec. 17, 2020

(54) LEVERAGING RESERVED DATA CENTER RESOURCES TO IMPROVE DATA CENTER UTILIZATION

(71) Applicant: Microsoft Technology Licensing, LLC, Redmond, WA (US)

(72) Inventors: Ioannis MANOUSAKIS, Heraklion (GR); Christian L. BELADY, Mercer Island, WA (US); Osvaldo P. MORALES, Normandy Park, WA (US); Ricardo Gouvêa BIANCHINI, Bellevue, WA (US); Marcus F. FONTOURA, Medina, WA (US); Alok Gautam KUMBHARE, Redmond, WA (US); Girish S. BABLANI, Bellevue, WA (US); Lalu Vannankandy KUNNATH, Snoqualmie, WA (US); Steve Todd SOLOMON, Kirkland, WA (US); David Thomas GAUTHIER, Seattle, WA (US)

(21) Appl. No.: 16/440,764

(22) Filed: Jun. 13, 2019

(51) Int. Cl. G06F 9/50; G06F 1/3206; G06F 1/329; G06F 9/455

(52) U.S. Cl. CPC G06F 9/5094; G06F 1/3206; G06F 2009/45575; G06F 9/45558; G06F 1/329

(57) ABSTRACT

A method for facilitating increased utilization of a data center includes receiving information about availability of components in a data center's electrical infrastructure and about power consumption of servers in the data center. The method may also include detecting that the power consumption of the servers in the data center exceeds a reduced total capacity of the electrical infrastructure. The reduced total capacity may be caused by unavailability of at least one component in the data center's electrical infrastructure. The method may also include causing power management to be performed to reduce the power consumption of the servers so that the power consumption of the servers does not exceed the reduced total capacity of the electrical infrastructure of the data center.

### CROSS-REFERENCE TO RELATED APPLICATIONS

N/A

### BACKGROUND

A data center is a physical facility that is used to house computer systems and associated components. A data center typically includes a large number of servers, which may be stacked in racks that are placed in rows. A colocation center (which is sometimes referred to simply as a “colo”) is a type of data center where equipment, space, and bandwidth are available for rental to customers.

The electrical infrastructure of a data center (such as a colocation center) includes a connection to the main power grid, which is typically provided by the local utility company. The electricity from the local utility company is typically delivered with a medium voltage. The medium-voltage electricity is then transformed by one or more transformers to low voltage for use within the data center. To ensure uninterrupted operation even in the case of a large-scale power outage, data centers are typically connected to at least one backup generator. Electricity from the backup generator may be delivered at low voltage, or it may be delivered at medium voltage and then transformed to low voltage for use within the data center. The low-voltage electricity is distributed to endpoints through one or more Uninterrupted Power Supply (UPS) systems and one or more power distribution units (PDUs). A UPS system provides short-term power when the input power source fails and protects critical components against voltage spikes, harmonic distortion, and other common power problems. A PDU includes multiple outputs that are designed to distribute electric power to racks of computers and networking equipment located within a data center.

The electrical infrastructure of a data center may utilize a distributed, redundant architecture that includes a plurality of different cells. Each of the cells may include its own power supply system. In this context, the term “power supply system” may refer to one or more components that provide a source of power to at least some of the servers and/or other components in the data center. A power supply system may include one or more of the components described previously (e.g., a connection to the main grid, a backup generator, one or more transformers, a UPS system, and one or more PDUs).

The power supply systems in different cells may be independent of each other. Thus, it is possible for one or more power supply systems of a data center to become unavailable (e.g., due to planned maintenance or component failure) while the other power supply system(s) of the data center are still available. In a data center whose electrical infrastructure includes a distributed, redundant architecture, the electrical infrastructure may be configured such that each server in the data center draws power from at least two different power supply systems. When a power supply system becomes unavailable, the load that was being provided by the now unavailable power supply system may be shifted to one or more other power supply systems. Thus, the amount of power that is supplied by at least some of the other power supply systems in the data center may be increased, at least temporarily. This may present challenges related to ensuring that none of the components of the remaining power supply systems become overloaded, which could potentially lead to system outages. As such, data centers that employ distributed redundant architectures typically maintain excess, reserved power capacity in all power supply systems to cover this overload condition

### SUMMARY

In accordance with one aspect of the present disclosure, a method is disclosed for facilitating increased utilization of a data center. The method may include receiving information about availability of components in an electrical infrastructure of the data center and about power consumption of servers in the data center. The method may also include detecting that the power consumption of the servers in the data center exceeds a reduced total capacity of the electrical infrastructure of the data center. The reduced total capacity may be caused by unavailability of at least one component in the electrical infrastructure of the data center. The method may also include causing power management to be performed to reduce the power consumption of the servers so that the power consumption of the servers does not exceed the reduced total capacity of the electrical infrastructure of the data center.

The reduced total capacity may be caused by a power supply system becoming unavailable. The electrical infrastructure of the data center may be configured such that each server draws power from at least two different power supply systems. An amount of power that is supplied by other power supply systems in the data center may be increased when the power supply system is unavailable.

The utilization of the data center may be designed such that the power consumption of the servers in the data center does not exceed a total capacity of the electrical infrastructure of the data center when all power supply systems in the electrical infrastructure of the data center are operational. The utilization of the data center may also be designed such that the power consumption of the servers in the data center can potentially exceed the total capacity of the electrical infrastructure of the data center when a power supply system in the electrical infrastructure of the data center is unavailable.

Causing the power management to be performed may include causing the power management to be performed in a normal mode and causing the power management to be performed in a degraded mode when at least one condition is satisfied. The power management may be performed more aggressively in the degraded mode than in the normal mode.

Causing the power management to be performed may include causing power capping to be applied to at least some of the servers in the data center. The power capping may restrict how much power affected servers are permitted to consume. Different power capping limits may be applied to different servers based on relative priority of the different servers.

Causing the power capping to be applied may include causing the power capping to be performed in a normal mode and causing the power capping to be performed in a degraded mode when at least one condition is satisfied. The power capping may use more restrictive power limits in the degraded mode than in the normal mode.

Causing the power management to be performed may include at least one of causing at least some of the servers in the data center to be shut down, causing at least some of the servers in the data center to enter a low power state, or causing at least some virtual machines running on at least some of the servers in the data center to be shut down.

The information about the availability of the power supply systems and about the power consumption of the servers may be received from at least two separate electrical monitoring paths.

Over a time period during which the data center is in operation, the power management may be performed less than one percent of the time period.

A method for facilitating increased utilization of a data center may include receiving a request to perform power management to reduce power consumption of servers in a data center. The request may be received in response to an entity detecting that the power consumption of the servers in the data center exceeds a reduced total capacity of the electrical infrastructure of the data center. The method may also include sending power management commands to at least some of the servers in the data center in response to receiving the request.

The method may be implemented by a power management service. The entity that detects that the power consumption of the servers in the data center exceeds the reduced total capacity may include another service that is distinct from the power management service.

The reduced total capacity may be caused by a power supply system becoming unavailable. The utilization of the data center may be designed such that the power consumption of the servers in the data center does not exceed a total capacity of the electrical infrastructure of the data center when all power supply systems in the electrical infrastructure of the data center are operational, and the power consumption of the servers in the data center can potentially exceed the total capacity of the electrical infrastructure of the data center when the power supply system in the electrical infrastructure of the data center is unavailable.

The power management commands may include power capping commands that limit how much power affected servers are permitted to consume. Different power capping limits may be applied to different servers based on relative priority of the different servers.

The power management commands may include shutdown commands that may cause one or more servers to be shut down. The order in which different servers are shut down may be based on relative priority of the different servers.

In accordance with another aspect of the present disclosure, a method is disclosed for facilitating increased utilization of a data center. The method may include receiving power management commands for a plurality of servers in a data center. The power management commands may be received from a power management service. The power management service may send the power management commands in response to an entity detecting that power consumption of servers in the data center exceeds a reduced total capacity of an electrical infrastructure of the data center. The method may also include performing power management with respect to at least some of the plurality of servers based on the power management commands.

The plurality of servers may be included in a server rack. The method may be implemented by a server rack manager. The entity that detects that the power consumption of the servers in the data center exceeds the reduced total capacity may include another service that is distinct from the power management service and from the server rack manager.

The power management commands may include power capping commands. The method may further include applying power capping limits to the set of servers based on the power capping command. Different power capping limits may be applied to different servers based on relative priority of the different servers.

The power management commands may include shutdown commands, and the method may further include shutting down one or more servers based on the shutdown commands. The order in which different servers are shut down may be based on relative priority of the different servers.

The power management commands may include shutdown commands, and the method may further include shutting down one or more virtual machines based on the shutdown commands. The order in which different virtual machines are shut down may be based on relative priority of the different virtual machines.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1A illustrates an example showing how the total capacity, the primary capacity, and the reserve capacity for a data center's electrical infrastructure may vary over time in a scenario where none of the reserve capacity is used during normal operation.

FIG. 1B illustrates an example showing how the total capacity, the primary capacity, and the reserve capacity for a data center's electrical infrastructure may vary over time in a scenario where at least some of the reserve capacity is used during normal operation.

FIG. 2A illustrates an example of a distributed, redundant architecture for a data center's electrical infrastructure when all power supply systems are operational.

FIG. 2B illustrates an example of a distributed, redundant architecture for a data center's electrical infrastructure when one power supply system is not operational.

FIG. 3 illustrates an example of a system in which a flexible capacity service may be implemented.

FIG. 4 illustrates an example of power management techniques that involve power capping.

FIG. 5A illustrates another example of a distributed, redundant architecture for a data center's electrical infrastructure when all power supply systems are operational.

FIG. 5B illustrates another example of a distributed, redundant architecture for a data center's electrical infrastructure when one power supply system is not operational.

FIGS. 6A and 6B illustrate an example of a power management service that is configured to operate in a normal mode and in a degraded mode.

FIG. 7 illustrates an example of a method for facilitating increased utilization of a data center that may be implemented by a real-time telemetry service.

FIG. 8 illustrates an example of a method for facilitating increased utilization of a data center that may be implemented by a power management service.

FIG. 9 illustrates an example of a method for facilitating increased utilization of a data center that may be implemented by a rack manager in a server rack.

FIG. 10 illustrates certain components that may be included within a computing system.

### DETAILED DESCRIPTION

The present disclosure is generally related to techniques for improving data center utilization. The techniques disclosed herein may be implemented in any type of data center, including but not limited to a colocation center.

For the sake of example, at least some of the techniques disclosed herein will be described in relation to a data center that uses a distributed, redundant electrical infrastructure. As noted above, in such a data center the electrical infrastructure may be configured such that each server in the data center draws power from at least two different power supply systems, which may be independent of one another. However, the scope of the present disclosure should not be limited to a distributed, redundant topology. The techniques disclosed herein may also be applied to other data center electrical architectures, including block redundant and system redundant.

From time to time, a power supply system in a data center's electrical infrastructure may become unavailable. The unavailability of a power supply system may be due to a planned event or an unplanned event. One example of planned unavailability is when a power supply system becomes unavailable because of planned maintenance that is being performed on the power supply system. One example of unplanned unavailability is when a power supply system becomes unavailable because of the unexpected failure of one or more components within the power supply system.

The amount of power that a data center's electrical infrastructure is capable of reliably supplying may be referred to as the total capacity of the electrical infrastructure. Although much of the total capacity of the electrical infrastructure is allocated for providing power to servers, some of the total capacity is used for other purposes (e.g., providing power to the data center's cooling systems). Generally speaking, the utilization of a data center should be limited so that the servers' total power consumption is less than the total capacity. If the utilization of a data center is not limited in this way and the servers' total power consumption is permitted to exceed (or even approach) the total capacity of the electrical infrastructure for long periods of time, this may cause one or more components in the electrical infrastructure to fail, thereby causing a loss of power to the data center (or at least certain parts of the data center).

In this context, the “utilization” of a data center may refer generally to the extent to which the data center is being used to house computer systems and associated components, and the extent to which those computer systems and associated components are being used to perform operations that use power (e.g., computing and/or communication operations). Some examples of metrics that may be indicative of the utilization of a data center include the amount of power consumed by servers (or server racks) in the data center, the number of servers in the data center, the central processing unit (CPU) utilization of the servers in the data center, the CPU load, the amount of memory and storage that are being used in the data center's servers, the amount of network traffic involving the data center's computer systems and associated components, and the amount of airflow that is supplied and consumed by servers.

In order to allow for maintenance and component failure, the utilization of a data center may be limited so that the data center's electrical infrastructure has a certain amount of reserve capacity under normal circumstances. In other words, the utilization of a data center may be limited so that the servers' total power consumption does not exceed a threshold level that is lower than the electrical infrastructure's total capacity. This threshold level may be referred to herein as the primary capacity of the electrical infrastructure.

For example, suppose that the total capacity of a data center's electrical infrastructure is Pₜₒₜₐₗ when all of the power supply systems in the electrical infrastructure are operational. The utilization of a data center may be limited so that the servers' total power consumption (even during utilization spikes) does not exceed P_{primary}, where P_{primary}<Pₜₒₜₐₗ. The difference between Pₜₒₜₐₗ and P_{primary} is the reserve capacity, which remains unused during normal operation.

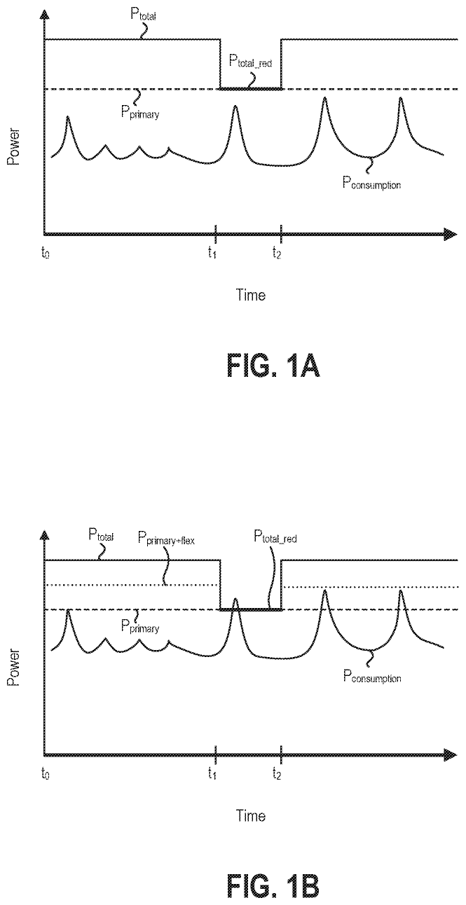

The reserve capacity of a data center's electrical infrastructure is intended to allow the electrical infrastructure to maintain smooth operation and prevent overloading (even in the face of utilization spikes) when a power supply system in the electrical infrastructure is not operational. An example showing how the reserve capacity may be utilized is illustrated in FIG. 1A. The graph shown in FIG. 1A illustrates how the total capacity (Pₜₒₜₐₗ), the primary capacity (P_{primary}), and the reserve capacity (Pₜₒₜₐₗ−P_{primary}) for a data center's electrical infrastructure may vary over time. FIG. 1A also illustrates how the power consumption (P_{consumption}) of the servers in the data center may vary over time.

In the depicted example, all of the power supply systems in the electrical infrastructure of the data center are operational during a first time period (from t₀ to t₁). During this time period, the total capacity (Pₜₒₜₐₗ) exceeds the primary capacity (P_{primary}), and there is a certain (non-zero) amount of reserve capacity.

During a second time period (from t₁ to t₂), one of the power supply systems in the electrical infrastructure of the data center is not operational (e.g., due to planned maintenance or component failure). This reduces the total capacity of the electrical infrastructure. The reduced total capacity is labeled P_{total_red} in FIG. 1A. In this example it will be assumed that the reduced total capacity equals the primary capacity (P_{total_red}=P_{primary}), so that there is no reserve capacity during this time period. However, because the utilization of the data center is limited so that the servers' total power consumption (even during utilization spikes) does not exceed P_{primary}, and because P_{primary} equals P_{total_red} in this example, no system outages should occur even when one of the power supply systems is unavailable.

During a third time period (from t₂ onward), all of the components in the electrical infrastructure of the data center are operational again. The total capacity increases back to Pₜₒₜₐₗ, which exceeds P_{primary}. Thus, there is once again a certain (non-zero) amount of reserve capacity.

The reserve capacity allows the electrical infrastructure to tolerate the utilization spike that occurs during the second time period. To see why, consider what would have happened if the electrical infrastructure had been designed without any reserve capacity (i.e., so that the total capacity when all components are operational is at the level of P_{primary} in FIG. 1A). In this scenario, during the second time period when one of the power supply systems is not operational and the total capacity has been reduced, the utilization spike would likely have caused the total power consumption of the servers in the data center (P_{consumption}) to exceed the reduced total capacity (P_{total_red}) of the electrical infrastructure. This could cause a system outage. Therefore, having some reserve capacity can be beneficial in order to ensure that the servers within the data center remain available.

However, there are disadvantages associated with having too much reserve capacity. The greater the amount of reserve capacity that is available, the greater the limits on the extent to which the data center can be utilized (e.g., fewer servers, less utilization of the servers). This drives up the cost of operating a data center. Accordingly, benefits may be realized by techniques that allow a data center's electrical infrastructure to tolerate the unavailability of one or more components of a power supply system without requiring as much reserve capacity as is necessary in current approaches.

One aspect of the present disclosure is generally related to facilitating increased utilization of a data center by using at least some portion of an electrical infrastructure's reserve capacity during normal operation. The amount of the reserve capacity that is being utilized may be referred to herein as the flexible capacity. The use of this flexible capacity enables a data center having a given electrical infrastructure to be utilized more fully (e.g., to have more servers, more virtual machines, more applications), thereby improving efficiency and reducing the cost associated with operating a data center.

However, as the aforementioned example illustrates, it would be problematic to simply eliminate the reserve capacity without providing a mechanism for addressing situations when a power supply system is not operational. If the reserve capacity is simply eliminated, without more, then utilization spikes that occur when a power supply system is unavailable could potentially lead to system outages. To prevent system outages from occurring when some reserve capacity is being used during normal operation and a power supply system becomes unavailable, various power management techniques may be utilized. Examples of such power management techniques will be described herein.

FIG. 1B illustrates an example in which some of the reserve capacity of a data center's electrical infrastructure may be used during normal operation in accordance with the present disclosure. For purposes of the present example, it will be assumed that the total capacity of the data center's electrical infrastructure at full operation is the same in both FIGS. 1A and 1B. Thus, Pₜₒₜₐₗ in FIG. 1A corresponds to Pₜₒₜₐₗ in FIG. 1B. It will also be assumed that P_{primary} in FIG. 1A corresponds to P_{primary} in FIG. 1B.

There is an additional line in FIG. 1B that is labeled P_{primary+flex}. This corresponds to the sum of the primary capacity and the flexible capacity (i.e., the amount of the reserve capacity that is being used during normal operation). In the example shown in FIG. 1B, the utilization of the data center is limited so that the servers' total power consumption (even during utilization spikes) does not exceed P_{primary+flex}. By contrast, in the example shown in FIG. 1A, the utilization of the data center is limited so that the servers' total power consumption does not exceed P_{primary}. Since P_{primary+flex}>P_{primary}, the utilization of the data center is greater in the example shown in FIG. 1B than in the example shown in FIG. 1A. In other words, in the example shown in FIG. 1B, the data center can include more servers and utilize the servers to a greater extent (e.g., include more virtual machines, run more applications) than in the example shown in FIG. 1A. This makes the servers' total power consumption greater in FIG. 1B than it is in FIG. 1A.

The example shown in FIG. 1B is similar to the example shown in FIG. 1A in that all of the power supply systems in the data center's electrical infrastructure are operational during a first time period (from t₀ to t₁), but one of the power supply systems is not operational during a second time period (from t₁ to t₂). Because of the loss of one of the power supply systems from t₁ to t₂, the total capacity of the electrical infrastructure is reduced to P_{total_red} during this time period. It will be assumed that P_{total_red} is equal to P_{primary}, as it was in FIG. 1A. However, in the example shown in FIG. 1B the data center is being utilized to a greater extent, and the servers' total power consumption in FIG. 1B sometimes exceeds P_{primary}. Because P_{primary} equals P_{total_red}, this means that the servers' total power consumption in FIG. 1B may sometimes exceed P_{total_red} during the second time period. For example, when the utilization spike occurs shortly after time t₁, the servers' total power consumption exceeds P_{total_red}. When the servers' total power consumption exceeds P_{total_red}, the electrical infrastructure can become overloaded, which may cause a system outage to occur.

To prevent a system outage from occurring, power management techniques may be performed in response to detecting that the servers' total power consumption exceeds P_{total_red}. There are many different types of power management techniques that may be utilized in accordance with the present disclosure. Several examples will be described below. The goal of the power management techniques is to reduce the servers' total power consumption so that it no longer exceeds P_{total_red}.

During a third time period (from t₂ onward), all of the power supply systems in the data center's electrical infrastructure are operational again. Therefore, the total capacity of the electrical infrastructure returns to Pₜₒₜₐₗ, and the power management techniques may be discontinued.

In accordance with one aspect of the present disclosure, a flexible capacity service may be provided that facilitates increased data center utilization by enabling at least some portion of the reserve capacity of a data center's electrical infrastructure to be used during normal operation without causing system outages. The flexible capacity service may receive real-time information about the power consumption of servers in the data center and the availability of the power supply systems in the electrical infrastructure. In response to detecting that a power supply system within a data center's electrical infrastructure has become unavailable and that the total power consumption of the data center's servers exceeds the reduced total capacity of the data center's electrical infrastructure (e.g., the total capacity after taking into consideration the loss of the power supply system that has become unavailable), the flexible capacity service may perform one or more power management techniques in order to reduce the total power consumption below the reduced total capacity.

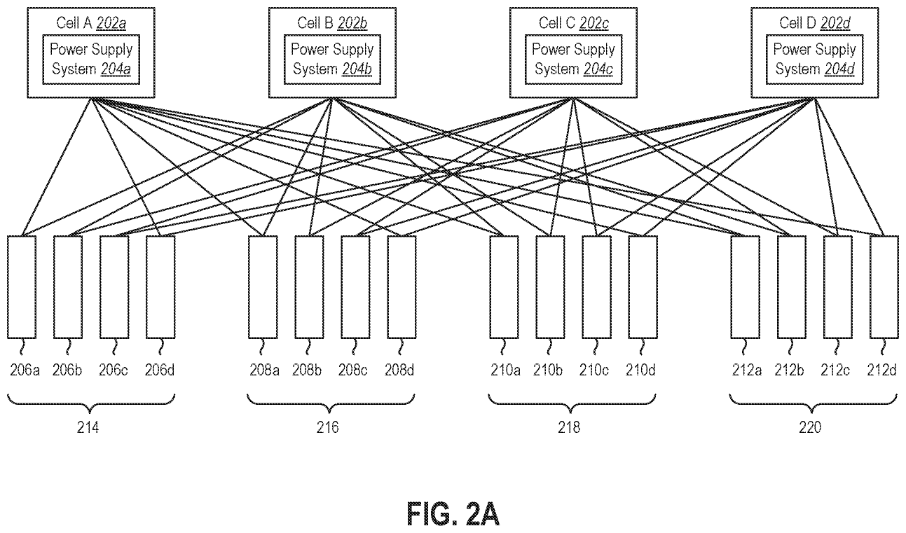

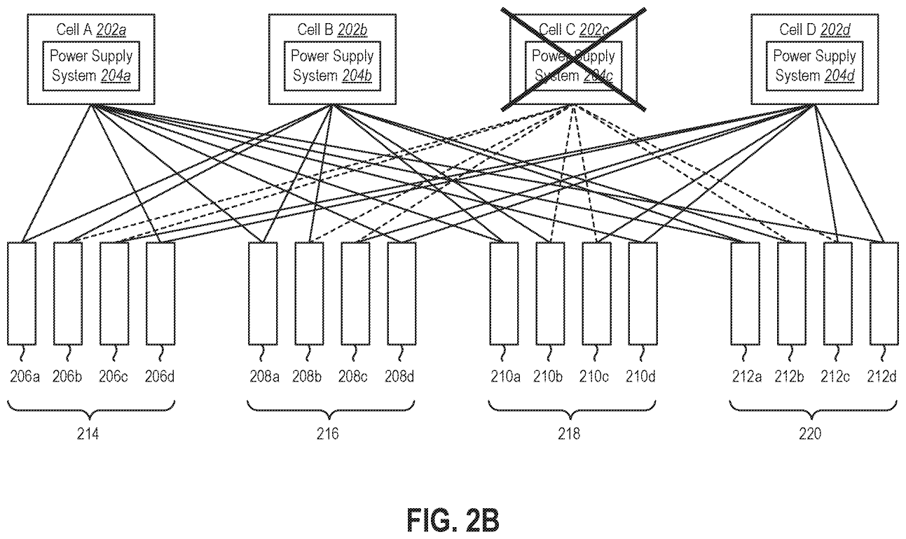

FIG. 2A illustrates an example of a distributed, redundant architecture for a data center. In this example, it will be assumed that the data center includes four cells 202a-d. These cells 202a-d will be referred to as cell A 202a, cell B 202b, cell C 202c, and cell D 202d. Each of the cells 202a-d includes a power supply system. In particular, cell A 202a includes a power supply system 204a, cell B 202b includes a power supply system 204b, cell C 202c includes a power supply system 204c, and cell D 202d includes a power supply system 204d.

The data center includes a plurality of servers, which may be contained in racks. In this context, the term “rack” may refer to a physical structure that holds servers. In the depicted example, the data center includes four sets of racks. These sets of racks will be referred to as set A 214, set B 216, set C 218, and set D 220. Each set of racks includes four racks. In particular, set A 214 includes racks 206a-d, set B 216 includes racks 208a-d, set A 218 includes racks 210a-d, and set A 220 includes racks 212a-d.

Each server in the data center draws power from the power supply system of at least two different cells. For example, consider the servers in set A 214. The servers in the first rack 206a receive power from the power supply system 204a of cell A 202a and also from the power supply system 204b of cell B 202b. The servers in the second rack 206b receive power from the power supply system 204b of cell B 202b and also from the power supply system 204c of cell C 202c. The servers in the third rack 206c receive power from the power supply system 204c of cell C 202c and also from the power supply system 204d of cell D 202d. The servers in the fourth rack 206d receive power from the power supply system 204d of cell D 202d and also from the power supply system 204a of cell A 202a. The electrical infrastructure may be configured similarly with respect to the servers in the other sets of racks 216, 218, 220, so that the servers in these sets of racks 216, 218, 220 also draw power from the power supply system of at least two different cells.

Of course, the particular configuration shown in FIGS. 2A and 2B is just an example and should not be interpreted as limiting the scope of the present disclosure. There are other alternative configurations for the cells 202a-d and the server racks 206a-d that are consistent with the present disclosure. In other words, the cells 202a-d and the server racks 206a-d, 208a-d, 210a-d, 212a-d may be connected in different ways and still utilize the techniques disclosed herein.

As noted above, one or more of the power supply systems within a data center's electrical infrastructure may become unavailable from time to time. The electrical infrastructure may be configured so that, when a power supply system becomes unavailable, the amount of power that is supplied by at least some of the other power supply systems in the data center may be increased.

As an example, consider the loss of the power supply system 204c in cell C 202c. When the power supply system 204c in cell C 202c is operational (as shown in FIG. 2A), it supplies power to the second rack 206b and the third rack 206c in set A 214, the second rack 208b and the third rack 208c in set B 216, the second rack 210b and the third rack 210c in set C 218, and the second rack 212b and the third rack 212c in set D 220. When the power supply system 204c in cell C 202c is unavailable (as shown in FIG. 2B), the load from the servers in these racks 206b-c, 208b-c, 210b-c, 212b-c may be transferred from the power supply system 204c in cell C 202c to other power supply systems 204a, 204b, 204d in other cells 202a, 202b, 202d.

Consider a numerical example. Suppose that the total capacity of each of the power supply systems 204a-d in each of the cells 202a-d is 2.4 MW. Because there are four cells 202a-d in this example, this means that the total capacity (Pₜₒₜₐₗ) of the data center's electrical infrastructure is 9.6 MW in this example. Further suppose that the utilization of the data center is limited so that the servers' total power consumption (even during utilization spikes) does not exceed 7.2 MW. In other words, suppose that the primary capacity (P_{primary}) of the data center's electrical infrastructure is 7.2 MW, thereby enabling each set of servers to draw 1.8 MW under normal operation. This leaves a reserve capacity of 2.4 MW (the difference between the total capacity of 9.6 MW and the primary capacity of 7.2 MW), which is equal to the total capacity of one of the power supply systems 204a-d in one of the cells 202a-d.

Having this much reserve capacity allows the electrical infrastructure to maintain smooth operation and prevent system outages from occurring when one of the power supply systems 204a-d becomes unavailable. Consider an example in which the power supply system 204c in cell C 202c becomes unavailable, as shown in FIG. 2B. Since the total capacity of each of the power supply systems 204a-d in each of the cells 202a-d is 2.4 MW and there are three available cells (cell A 202a, cell B 202b, and cell D 202d), the reduced total capacity of the data center's electrical infrastructure is 7.2 MW when the power supply system 204c in cell C 202c is unavailable. If the utilization of the data center is limited so that the servers' total power consumption (even during utilization spikes) does not exceed 7.2 MW, no system outages should occur even when the power supply system 204c in cell C 202c is unavailable. This is the scenario that is illustrated in FIG. 1A.

However, this type of approach is relatively inefficient because it leaves a significant amount of the electrical infrastructure's capacity unused most of the time. As discussed above, one aspect of the present disclosure is generally related to using at least some portion of an electrical infrastructure's reserve capacity during normal operation. For example, the data center's utilization may be increased so that the reserve capacity is less than the total capacity of one of the power supply systems in one of the cells.

Continuing with the previous example, suppose that the flexible capacity (i.e., the amount of the reserve capacity that is being used during normal operation) is 1 MW. In other words, suppose that the utilization of the data center is increased so that the servers' total power consumption is allowed to reach as much as 8.2 MW (1 MW more than the primary capacity, which is 7.2 MW in this example). This allows the servers in each set of racks 214, 216, 218, 220 to draw up to 2.05 MW during normal operation when all of the power supply systems 204a-d in all of the cells 202a-d are available. This allows additional utilization of the data center (e.g., additional servers, additional virtual machines, additional applications) compared to the previous arrangement in which the servers in each set of racks 214, 216, 218, 220 are only allowed to draw up to 1.8 MW.

When the power supply system 204c in cell C 202c becomes unavailable, the total capacity of the data center's electrical infrastructure is reduced to only 7.2 MW. Because the utilization of the data center is designed so that the limit on the servers' total power consumption is 8.2 MW, it is possible that the servers' total power consumption will exceed the reduced total capacity of the electrical infrastructure when the power supply system 204c in cell C 202c is unavailable. To prevent a system outage from occurring, the servers' total power consumption may be monitored. A service that performs that role will be referred to herein as a flexible capacity service. When the flexible capacity service detects that the servers' total power consumption exceeds the reduced total capacity of the electrical infrastructure, the flexible capacity service may take corrective action to reduce the servers' total power consumption. For example, the flexible capacity service may cause power management techniques to be implemented to reduce the amount of power that is drawn by the servers in each set of racks 214, 216, 218, 220 by a sufficient amount to prevent overloading (to 1.8 MW in the current example).

It is expected that power management will be performed relatively rarely. For example, one analysis indicated that the amount of time during which power management techniques are utilized would be, on average, approximately five hours per year per colocation center. Of course, the specific amount of time during which power management techniques are utilized will depend on how much reserve capacity is used during normal operation. In general, however, it is expected that over a particular time period during which the data center is in operation, power management will likely be performed less than one percent of that time period (and generally much less than one percent).

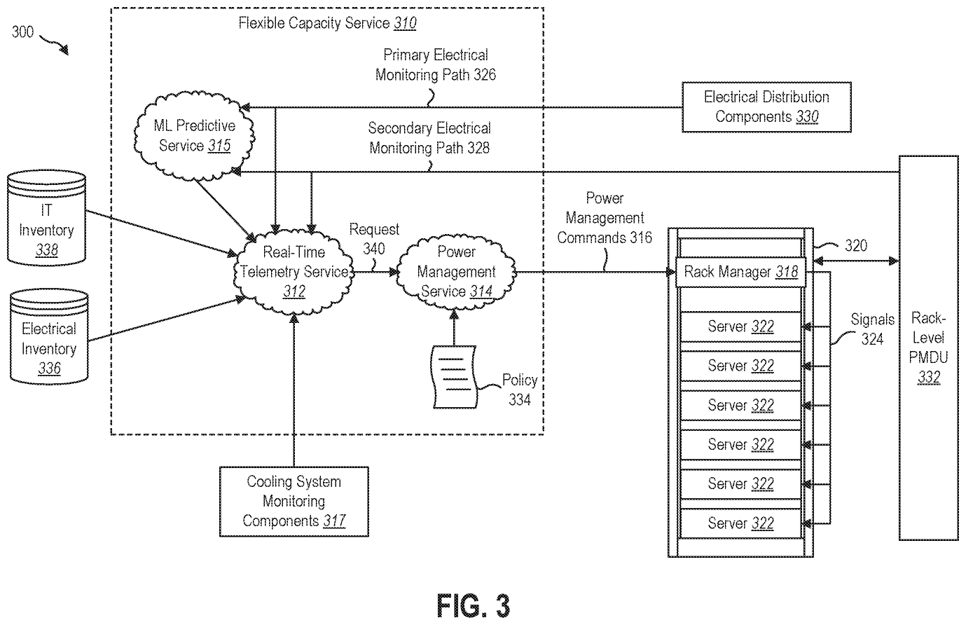

FIG. 3 illustrates an example of a system 300 in which the techniques disclosed herein may be utilized. The system 300 includes a flexible capacity service 310 for a data center. In general terms, the flexible capacity service 310 may facilitate increased utilization of a data center by reducing the likelihood that the increased utilization will cause system outages. More specifically, the flexible capacity service 310 may be configured to take corrective action whenever it detects that (i) the data center's electrical infrastructure is operating at less than total capacity (e.g., as a result of one or more components of a power supply system becoming unavailable), and (ii) the total power consumption of the data center's servers exceeds the reduced total capacity of the data center's electrical infrastructure. An example of a situation in which corrective action may be needed is when a power supply system in a cell of the data center's electrical infrastructure is unavailable and the total capacity of the data center's electrical infrastructure has been reduced to an amount that is less than the amount of power that may potentially be consumed by the data center's servers (e.g., where P_{total_red}<P_{primary+flex} in the example described previously).

The flexible capacity service 310 includes a real-time telemetry service 312 that receives real-time information about availability of power supply systems in the electrical infrastructure of the data center and about power consumption of servers in the data center. When the real-time telemetry service 312 determines that the total capacity of the data center's electrical infrastructure has been reduced (e.g., because one or more components in the electrical infrastructure have become unavailable) and that the power consumption of the servers in the data center exceeds the reduced total capacity of the data center's electrical infrastructure, the real-time telemetry service 312 may cause power management to be performed to reduce the power consumption of the servers to a point where the power consumption of the servers no longer exceeds the reduced total capacity of the data center's electrical infrastructure.

The real-time telemetry service 312 may also receive predictive information from a machine learning (ML) predictive engine 315. The ML predictive engine 315 may utilize machine learning methods to learn from server, cooling, and power consumption trends. For example, the ML predictive engine 315 may analyze data regarding the availability of power supply systems in the electrical infrastructure of the data center and the power consumption of servers in the data center over long periods of time. Based on this analysis, the ML predictive engine 315 may predict when the power consumption of the servers in the data center is likely to exceed one or more relevant thresholds. The real-time telemetry service 312 may cause power management to be performed in response to predictive information that it receives from the ML predictive engine 315.

The flexible capacity service 310 may also include a power management service 314. The real-time telemetry service 312 may coordinate with the power management service 314 to cause power management to be performed. For example, the real-time telemetry service 312 may send a request 340 to the power management service 314 that causes the power management service 314 to perform one or more power management operations to reduce the power consumption of at least some of the servers in the data center. In response to receiving the request 340, the power management service 314 may send power management commands 316 to at least some of the servers in the data center.

FIG. 3 shows an electrical inventory 336 and an IT inventory 338 being provided as inputs to the real-time telemetry service 312. The electrical inventory 336 may include information about the various components in the data center's electrical infrastructure. The IT inventory 338 may include information about the computer systems in the data center. The real-time telemetry service 312 may utilize the electrical inventory 336 and/or the IT inventory 338 when making determinations about the kinds of power management techniques that should be implemented and which system components (e.g., servers, virtual machines) should be affected. The power management techniques that are implemented may also depend to some extent on one or more policies 334 that have been defined. These policies 334 may include priority levels associated with at least some of the components in the data center.

FIG. 3 shows the power management service 314 sending power management commands 316 to a rack manager 318 in a server rack 320 that includes a plurality of servers 322. The rack manager 318 may be a physical computing device, or it could be a distributed service running on a plurality of servers 322. In response to receiving the power management commands 316, the rack manager 318 may perform power management with respect to at least some of the plurality of servers 322 in the server rack 320 based on the power management commands 316. This may involve sending signals 324 to one or more of the servers 322. In an alternative embodiment, the rack manager 318 may be omitted, and the power management service 314 may cause power management to be performed through another mechanism (e.g., by sending signals 324 directly to the servers 322).

As noted above, the real-time telemetry service 312 may receive real-time information about availability of power supply systems in the electrical infrastructure of the data center and about power consumption of servers in the data center. In some embodiments, the real-time telemetry service 312 may receive this information via at least two different electrical monitoring paths, which may be referred to herein as a primary electrical monitoring path 326 and a secondary electrical monitoring path 328. Having two separate electrical monitoring paths 326, 328 provides redundancy and increases the reliability of the real-time telemetry service 312. In the depicted example, the primary electrical monitoring path 326 corresponds to one or more higher-level electrical distribution components 330 within the power supply systems of the electrical infrastructure, and the secondary electrical monitoring path 328 corresponds to rack-level components such as power and management distribution units (PMDUs) 332.

The ML predictive engine 315 may also receive information about availability of power supply systems in the electrical infrastructure of the data center and about power consumption of servers in the data center from the primary electrical monitoring path 326 and/or the secondary electrical monitoring path 328. The ML predictive engine 315 may analyze this information to make predictions, as discussed above.

The flexible capacity service 310 may also receive information from one or more components that monitor aspects of the data center's cooling system. Such components are represented in FIG. 3 as cooling system monitoring components 317. The cooling system monitoring components 317 may monitor aspects of the data center's cooling system such as air handling unit (AHU) fan energy and server inlet air temperatures.

As discussed above, one aspect of the present disclosure is related to using at least some portion of an electrical infrastructure's reserve capacity during normal operation, and the amount of the reserve capacity that is being utilized may be referred to as the flexible capacity. In some embodiments, at least some of the power that is reserved for cooling capacity may also be considered to be flexible capacity. For instance, during a cool season, an additional amount of power could be redirected from components within the data center's cooling system (e.g., the air handler fans) to allow additional flexible capacity. The real-time telemetry service 312 may take into consideration information from the cooling system monitoring components 317 when making decisions about whether or not power management should be performed.

There are a variety of power management techniques that may be utilized in accordance with the present disclosure. Generally speaking, power management techniques degrade the performance of one or more computer system components (e.g., servers, virtual machines, applications) in order to lower power consumption. For example, power capping techniques may be utilized that limit how much power at least some of the servers in the data center are permitted to consume. This may be accomplished by limiting the CPU frequency of the affected servers. As another example, at least some of the servers in the data center may be placed in a low power state. As another example, at least some of the servers in the data center may be placed in a sleep mode. As another example, at least some of the servers in the data center may be shut down. As another example, in embodiments where at least some of the servers in the data center are running virtual machines, at least some of the virtual machines may be shut down. Virtual machines may be shut down without completely shutting down the servers (i.e., the host machines) on which the virtual machines are running. As another example, limits may be placed on the rate at which at least some of the servers in the data center receive and process read/write requests.

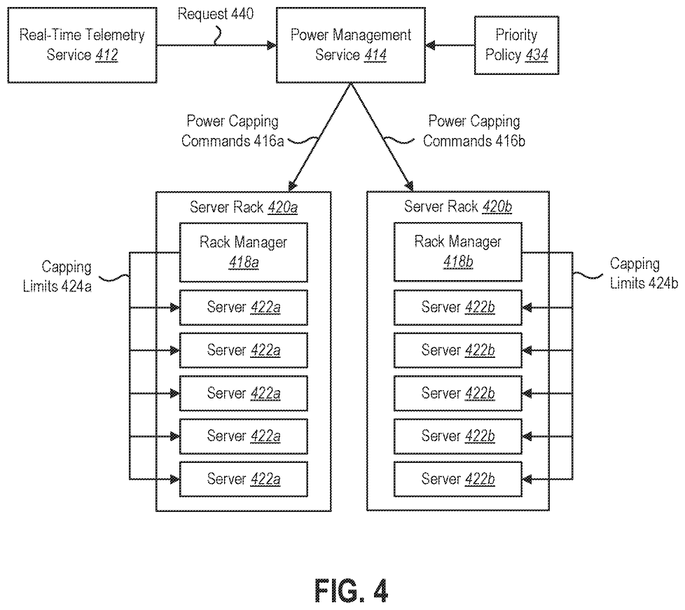

FIG. 4 illustrates an example of power management techniques that involve power capping. In response to determining that power management should be performed, the real-time telemetry service 412 may send a request 440 to the power management service 414. The request 440 may be interpreted by the power management service 414 as an instruction to perform power capping. In response to receiving the request 440, the power management service 414 may send power capping commands 416a-b to rack managers 418a-b in one or more server racks 420a-b in the data center. The power capping commands 416a-b may cause limits to be applied to the amount of power that is used by various servers 422a-b in the server racks 420a-b.

Different power capping limits may be applied to different servers 422a-b based on the relative priority of the servers 422a-b. The relative priority of at least some of the servers 422a-b in the data center may be defined in one or more policies. FIG. 4 shows a priority policy 434 being provided as input to the power management service 414. As an example, suppose that the priority policy 434 indicates that the servers 422a in the first server rack 420a are high priority and the servers 422b in the second server rack 420b are low priority. In this case, the power capping commands 416a-b may cause the least restrictive power capping limits to be applied to the high priority servers 422a in the first server rack 420a and the most restrictive power capping limits to be applied to the low priority servers 422b in the second server rack 420b. In other words, the power capping commands 416a-b may cause the amount of power used by the low priority servers 422b in the second server rack 420b to be limited to a greater extent than the high priority servers 422a in the first server rack 420a.

In response to receiving the power capping commands 416a-c, the rack managers 418a-b may apply power capping limits to the servers 422a-b based on the power capping commands 416a-b. This may involve sending signals including capping limits 424a-b to the servers 422a-b to which the relevant power capping limits apply. Continuing with the previous example, the signals that are sent to the high priority servers 422a may include power capping limits 424a that are less restrictive than the power capping limits 424b in the signals that are sent to the low priority servers 422b.

In some embodiments, other types of commands may be sent instead of (or in addition to) power capping commands 416a-b. For example, if power management techniques involve shutting down one or more servers, or placing one or more servers in a low power or sleep state, then the power management service 414 may send commands that place the server(s) in the desired state.

The order in which servers are shut down (or placed in a low power state) may be based on the relative priority of the servers. Lower priority servers may be shut down (or placed in a low power state) before higher priority servers. In some embodiments, the power management service 414 may maintain a server whitelist that indicates one or more high priority servers that are not to be shut down under any circumstances.

Similarly, the order in which virtual machines are shut down (or placed in a low power state) may be based on the relative priority of the virtual machines. Lower priority virtual machines may be shut down (or placed in a low power state) before higher priority virtual machines. In some embodiments, the power management service 414 may maintain a virtual machine whitelist that indicates one or more high priority virtual machines that are not to be shut down under any circumstances.

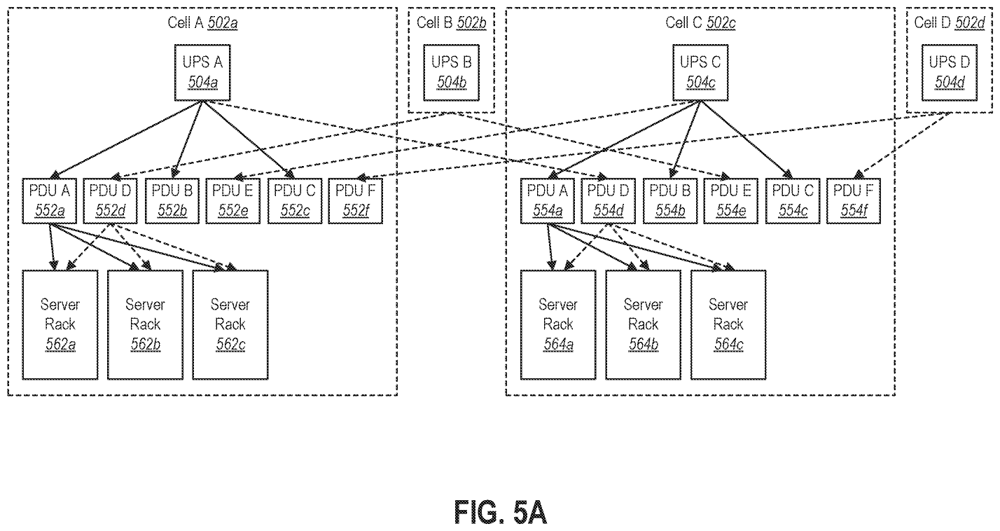

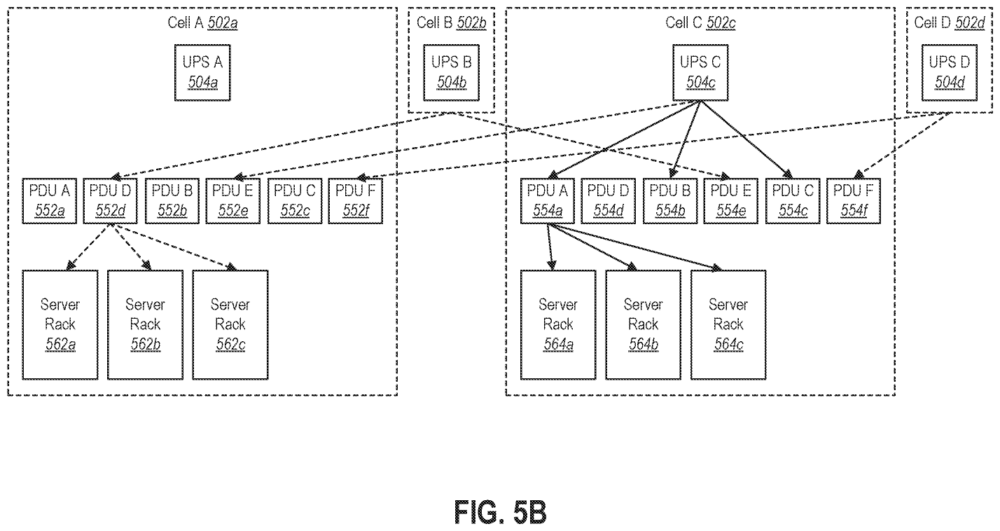

FIGS. 5A and 5B illustrate another example of a distributed, redundant architecture for a data center's electrical infrastructure in accordance with the present disclosure. As in the previous example, there are four cells (cell A 502a, cell B 502b, cell C 502c, and cell D 502d). Each cell includes a UPS. In particular, cell A 502a includes UPS A 504a, cell B 502b includes UPS B 504b, cell C 502c includes UPS C 504c, and cell D 502d includes UPS D 504d. Each cell also includes a plurality of PDUs. FIGS. 5A and 5B show the PDUs 552a-f in cell A 502a and the PDUs 554a-f in cell C 502c. Cell B 502b and cell D 502d may include similar sets of PDUs, but they are not shown in FIGS. 5A and 5B for the sake of simplicity.

In the depicted example, the data center's electrical infrastructure is designed so that the PDUs in a particular cell receive power from UPSes in a plurality of different cells. FIG. 5A illustrates how the PDUs 552a-f in cell A 502a receive power when all of the power supply systems in the electrical infrastructure are operational. As shown, PDU A 552a, PDU B 552b, and PDU C 552c receive power from UPS A 504a in cell A 502a. PDU D 552d receives power from UPS B 504b in cell B 502b. PDU E 552e receives power from UPS C 504c in cell C 502c. PDU F 552f receives power from UPS D 504d in cell D 502d.

Each pair of PDUs provides power to a set of server racks. For example, in cell A 502a, PDU A 552a and PDU D 552d provide power to a set of server racks 562a-c. In cell C 502c, PDU A 554a and PDU D 554d provide power to a set of server racks 564a-c. The other PDUs provide power to other server racks in a similar manner, but this is not shown in FIGS. 5A and 5B for the sake of simplicity.

As shown in FIG. 5B, the server racks 562a-c in cell A 502a continue receiving power if UPS A 504a becomes unavailable. More specifically, when UPS A 504a is unavailable, only some of the PDUs 552a-f in cell A 502a (PDU A 552a, PDU B 552b, and PDU C 552c) no longer receive power. PDU D 552d continues receiving power from UPS B 504b, PDU E 552e continues receiving power from UPS C 504c, and PDU F 552f continues receiving power from UPS D 504d. Therefore, PDU D 552d continues supplying power to the server racks 562a-c. PDU E 552e and PDU F 552f continue supplying power to other server racks (not shown). In cell C 502c, PDU D 554d stops receiving power from UPS A 504a. However, the other PDUs 554a, 554b, 554c, 554e, 554f continue receiving power and supplying it to server racks (including the server racks 564a-c shown in FIG. 5B).

As discussed above, one aspect of the present disclosure involves using at least some portion of an electrical infrastructure's reserve capacity during normal operation. An example will now be discussed showing how the use of some reserve capacity may affect the operation of the various components shown in FIGS. 5A and 5B.

As in the example discussed previously, it will be assumed that the total capacity of the electrical infrastructure is 9.6 MW (i.e., each of the four UPSes 504a-d is capable of reliably supplying 2.4 MW). Suppose that the primary capacity is set at 7.2 MW. In other words, suppose that the utilization of the data center is limited so that the servers' total power consumption does not exceed 7.2 MW. This would make the reserve capacity equal to 2.4 MW (which is the maximum capacity of one of the UPSes 504a-d). Under normal circumstances, when all of the UPSes 504a-d are operational, each of the UPSes 504a-d would supply up to 1.8 MW, and each of the PDUs 552a-f, 554a-f would supply up to 0.3 MW. If UPS A 504a becomes unavailable, then the load corresponding to UPS A 504a (and the PDUs 552a-c, 554d that were receiving power from UPS A 504a) may be shifted to the other UPSes 504b-d (and PDUs 552d-f, 554a). Therefore, each of the remaining UPSes 504b-d would supply up to 2.4 MW (their maximum capacity), and each of the PDUs 552d-f, 554a would supply up to 0.6 MW. Thus, the electrical infrastructure could tolerate UPS A 504a (or any of the UPSes 504a-d) becoming unavailable, but at the cost of leaving a significant amount of reserve capacity that is unused during normal operation.

The present disclosure proposes using some or all of that reserve capacity during normal operation in order to facilitate increased utilization of the data center. Instead of limiting the utilization of the data center so that the servers' total power consumption does not exceed 7.2 MW, suppose instead that this limit is set at 8.2 MW. This would reduce the reserve capacity to 1.4 MW (which is less than the maximum capacity of one of the UPSes 504a-d). With this amount of reserve capacity, then under normal circumstances (when all of the UPSes 504a-d are operational) each of the UPSes 504a-d would supply up to 2.05 MW, and each of the PDUs 552a-f, 554a-f would supply up to 0.34 MW. If UPS A 504a becomes unavailable, then simply shifting the load from UPS A 504a to the other UPSes 504b-d could cause the load on those UPSes 504b-d to be as high as 2.73 MW, which would exceed their maximum capacity and potentially cause a system outage. Therefore, as discussed above, the present disclosure proposes using power management techniques to reduce the servers' total power consumption so that none of the UPSes 504a-d exceeds its maximum capacity.

In some embodiments, there may be at least two different modes in which power management may be performed. As an example, a power management service may be capable of performing power management in a normal mode and also in a degraded mode. In this context, the term “degraded mode” may refer to the performance of at least some of the servers in the data center. In other words, power management may be performed more aggressively in the degraded mode than in the normal mode, thereby degrading the performance of at least some of the servers in the data center relative to the normal mode.

When power management is needed, power management may initially be performed in the normal mode. When one or more conditions are satisfied, power management may then be performed in the degraded mode. The condition(s) that trigger the degraded mode may be related to the power consumption of the servers in the data center. For example, the power management service may transition from the normal mode to the degraded mode when the servers' power consumption exceeds a threshold.

As noted above, in some embodiments power management involves power capping techniques that limit how much power at least some of the servers in the data center are permitted to consume. Power capping may be performed in a normal mode and also in a degraded mode. More restrictive power limits may be applied in the degraded mode than in the normal mode. In other words, at least some of the servers in the data center may be permitted to consume less power in the degraded mode than in the normal mode.

The example that was described above in connection with FIGS. 5A-B involved a data center that uses a distributed, redundant electrical infrastructure. As discussed above, however, the scope of the present disclosure should not be limited to a distributed, redundant topology. The techniques disclosed herein may also be applied to other data center electrical architectures, including block redundant and system redundant. In some embodiments, a server, server rack, or series of server racks could be powered from a transfer switch or automated circuit breakers that could be policy managed with a flexible capacity service (such as the flexible capacity service 310 shown in FIG. 3) to instantaneously power the servers down.

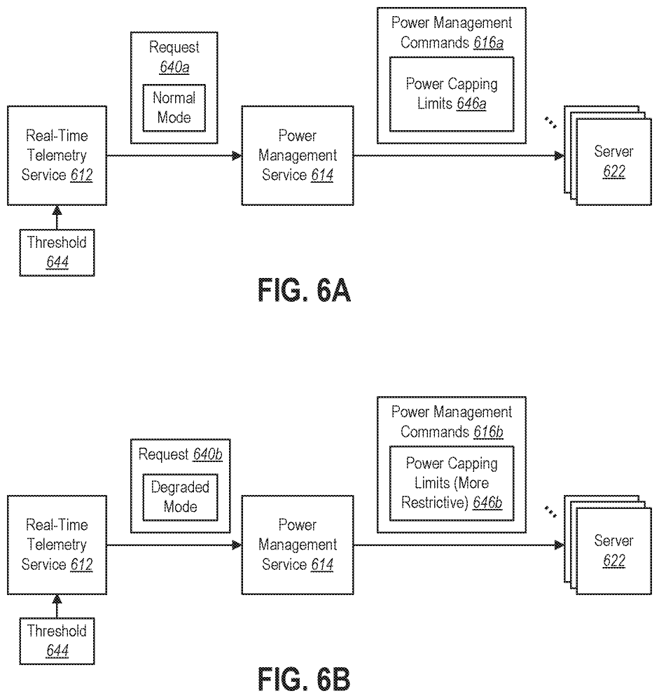

FIGS. 6A and 6B illustrate an example of a power management service 614 that is configured to operate in a normal mode and in a degraded mode. FIG. 6A shows the power management service 614 operating in a normal mode. FIG. 6B shows the power management service 614 operating in a degraded mode.

Referring initially to FIG. 6A, a real-time telemetry service 612 may determine that the total capacity of the data center's electrical infrastructure has been reduced and that the power consumption of the servers in the data center exceeds the reduced total capacity of the data center's electrical infrastructure. However, the servers' power consumption has not yet reached a threshold 644 that has been defined for invoking the degraded mode. Therefore, the real-time telemetry service 612 may send a request 640a to the power management service 614 to perform power management in normal mode. In response to receiving the request 640a, the power management service 614 may send power management commands 616a to at least some of the servers 622 in the data center. The power management commands 616a may correspond to the normal mode. For example, if power management involves power capping, the power management commands 616a may include power capping limits 646a corresponding to the normal mode.

Referring now to FIG. 6B, suppose that the real-time telemetry service 612 determines that the servers' power consumption has exceeded the threshold 644 that has been defined for invoking the degraded mode. Therefore, the real-time telemetry service 612 may send a request 640b to the power management service 614 to perform power management in degraded mode. In response to receiving the request 640b, the power management service 614 may send power management commands 616b to at least some of the servers 622 in the data center. If power management involves power capping, the power management commands 616b may include power capping limits 646b corresponding to the degraded mode. The power capping limits 646b corresponding to the degraded mode may be more restrictive than the power capping limits 646a corresponding to the normal mode. In other words, the power capping limits 646b corresponding to the degraded mode may permit at least some of the servers 622 in the data center to consume less power than the power capping limits 646a corresponding to the normal mode.

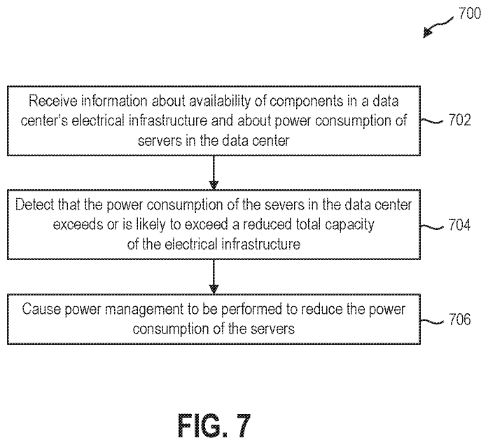

FIG. 7 illustrates an example of a method 700 for facilitating increased utilization of a data center. The method 700 may be implemented by a real-time telemetry service 312. The method 700 includes receiving 702 information about availability of components in a data center's electrical infrastructure and about power consumption of servers in the data center. This information may include real-time information that is received about current availability of power supply systems in the electrical infrastructure of the data center and about current power consumption of servers in the data center. Such information may be received from a primary electrical monitoring path 326 and a secondary electrical monitoring path 328. The real-time telemetry service 312 may also receive predictions from a machine learning (ML) predictive engine 315. For example, as discussed above, the real-time telemetry service 312 may receive predictions about when the power consumption of the servers in the data center is likely to exceed one or more relevant thresholds.

The method 700 also includes detecting 704 that the power consumption of the servers in the data center exceeds or is likely to exceed a reduced total capacity of the electrical infrastructure. For example, the operation of detecting 704 may involve making a determination that the power consumption of the servers exceeds the reduced total capacity of the electrical infrastructure based on the real-time information that is received about current availability of power supply systems and current power consumption of servers. As another example, the operation of detecting 704 may involve making a determination that the power consumption of the servers is likely to exceed one or more defined thresholds at some point in the future, based on predictive information received from the ML predictive engine 315.

The method 700 also includes causing 706 power management to be performed to reduce the power consumption of the servers. Power management may be performed in response to the previous operation of detecting 704 that the power consumption of the servers in the data center exceeds or is likely to exceed one or more relevant thresholds. Power management may be performed immediately (e.g., in response to a determination that the current power consumption of the servers exceeds the reduced total capacity of the electrical infrastructure), or it may be scheduled for some future point in time (e.g., in response to a determination that the power consumption of the servers is likely to exceed one or more defined thresholds at some point in the future).

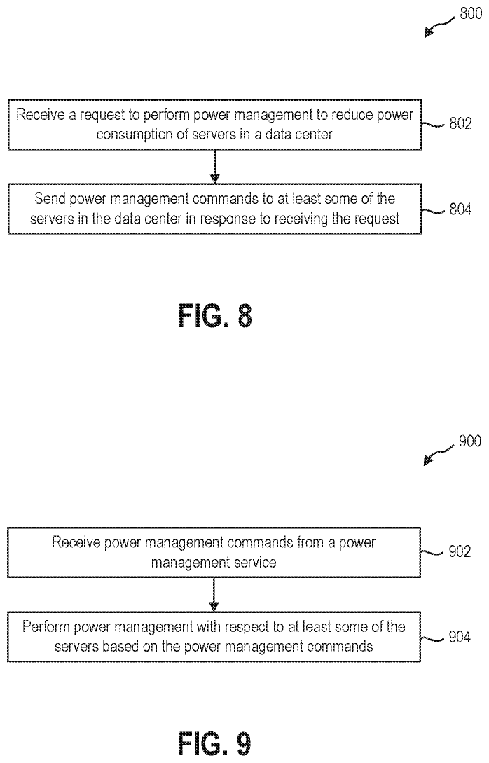

FIG. 8 illustrates another example of a method 800 for facilitating increased utilization of a data center. The method 800 may be implemented by a power management service 314. The method 800 includes receiving 802 a request to perform power management to reduce power consumption of servers in a data center. The method 800 also includes sending 804 power management commands to at least some of the servers in the data center in response to receiving the request.

FIG. 9 illustrates another example of a method 900 for facilitating increased utilization of a data center. The method 900 may be implemented by a rack manager 318 in a server rack 320. The method 900 includes receiving 902 power management commands 316 from a power management service 314. The method 900 also includes performing 904 power management with respect to at least some of the servers 322 in the server rack 320 based on the power management commands.

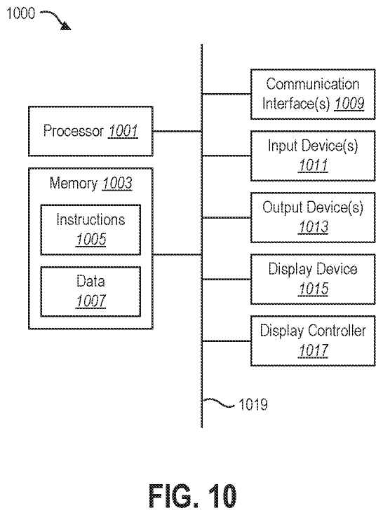

One or more computing systems may be used to implement a flexible capacity service (including a real-time telemetry service and a power management service) as disclosed herein. FIG. 10 illustrates certain components that may be included within a computing system 1000.

The computing system 1000 includes a processor 1001. The processor 1001 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). Although just a single processor 1001 is shown in the computing system 1000 of FIG. 10, in an alternative configuration, a combination of processors (e.g., an ARM and DSP) could be used.

The computing system 1000 also includes memory 1003 in electronic communication with the processor 1001. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor 1001, erasable programmable read-only memory (EPROM), electrically erasable programmable read-only memory (EEPROM) memory, registers, and so forth, including combinations thereof

Instructions 1005 and data 1007 may be stored in the memory 1003. The instructions 1005 may be executable by the processor 1001 to implement some or all of the methods, steps, operations, actions, or other functionality that is disclosed herein. Executing the instructions 1005 may involve the use of the data 1007 that is stored in the memory 1003. Unless otherwise specified, any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during execution of the instructions 1005 by the processor 1001.

The computing system 1000 may also include one or more communication interfaces 1009 for communicating with other electronic devices. The communication interface(s) 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing system 1000 may also include one or more input devices 1011 and one or more output devices 1013. Some examples of input devices 1011 include a keyboard, mouse, microphone, remote control device, button, joystick, trackball, touchpad, and lightpen. One specific type of output device 1013 that is typically included in a computing system 1000 is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015. The computing system 1000 may also include other types of output devices 1013, such as a speaker, a printer, etc.

The various components of the computing system 1000 may be coupled together by one or more buses, which may include a power bus, a control signal bus, a status signal bus, a data bus, etc. For the sake of clarity, the various buses are illustrated in FIG. 10 as a bus system 1019.

In some embodiments, the techniques disclosed herein may be implemented via a distributed computing system. A distributed computing system is a type of computing system whose components are located on multiple computing devices. For example, a distributed computing system may include a plurality of distinct processing, memory, storage, and communication components that are connected by one or more communication networks. The various components of a distributed computing system may communicate with one another in order to coordinate their actions.

In some embodiments, the techniques disclosed herein may be implemented via a cloud computing system. Broadly speaking, cloud computing is the delivery of computing services (e.g., servers, storage, databases, networking, software, analytics) over the Internet. Cloud computing systems are built using principles of distributed systems.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

In an example, the term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for facilitating increased utilization of a data center, comprising:
receiving information about availability of components in an electrical infrastructure of the data center and about power consumption of servers in the data center;
detecting that the power consumption of the servers in the data center exceeds a reduced total capacity of the electrical infrastructure of the data center, the reduced total capacity being caused by unavailability of at least one component in the electrical infrastructure of the data center; and
causing power management to be performed to reduce the power consumption of the servers so that the power consumption of the servers does not exceed the reduced total capacity of the electrical infrastructure of the data center.

2. The method of claim 1, wherein:
the reduced total capacity is caused by a power supply system becoming unavailable;
the electrical infrastructure of the data center is configured such that each server draws power from at least two different power supply systems; and
an amount of power that is supplied by other power supply systems in the data center is increased when the power supply system is unavailable.

3. The method of claim 1, wherein the utilization of the data center is designed such that:
the power consumption of the servers in the data center does not exceed a total capacity of the electrical infrastructure of the data center when all power supply systems in the electrical infrastructure of the data center are operational; and
the power consumption of the servers in the data center can potentially exceed the total capacity of the electrical infrastructure of the data center when a power supply system in the electrical infrastructure of the data center is unavailable.

4. The method of claim 1, wherein causing the power management to be performed comprises:
causing the power management to be performed in a normal mode; and
causing the power management to be performed in a degraded mode when at least one condition is satisfied, wherein the power management is performed more aggressively in the degraded mode than in the normal mode.

5. The method of claim 1, wherein:
causing the power management to be performed comprises causing power capping to be applied to at least some of the servers in the data center; and
the power capping restricts how much power affected servers are permitted to consume.

6. The method of claim 4, wherein different power capping limits are applied to different servers based on relative priority of the different servers.

7. The method of claim 1, wherein causing the power capping to be applied comprises:
causing the power capping to be performed in a normal mode; and
causing the power capping to be performed in a degraded mode when at least one condition is satisfied, wherein the power capping uses more restrictive power limits in the degraded mode than in the normal mode.

8. The method of claim 1, wherein causing the power management to be performed comprises at least one of:
causing at least some of the servers in the data center to be shut down;
causing at least some of the servers in the data center to enter a low power state; or
causing at least some virtual machines running on at least some of the servers in the data center to be shut down.

9. The method of claim 1, wherein the information about the availability of the power supply systems and about the power consumption of the servers is received from at least two separate electrical monitoring paths.

10. The method of claim 1, wherein over a time period during which the data center is in operation, the power management is performed less than one percent of the time period.

11. A method for facilitating increased utilization of a data center, comprising:
receiving a request to perform power management to reduce power consumption of servers in a data center, wherein the request is received in response to an entity detecting that the power consumption of the servers in the data center exceeds a reduced total capacity of the electrical infrastructure of the data center; and
sending power management commands to at least some of the servers in the data center in response to receiving the request.

12. The method of claim 10, wherein:
the method is implemented by a power management service; and
the entity that detects that the power consumption of the servers in the data center exceeds the reduced total capacity comprises another service that is distinct from the power management service.

13. The method of claim 10, wherein the reduced total capacity is caused by a power supply system becoming unavailable, and wherein the utilization of the data center is designed such that:
the power consumption of the servers in the data center does not exceed a total capacity of the electrical infrastructure of the data center when all power supply systems in the electrical infrastructure of the data center are operational; and
the power consumption of the servers in the data center can potentially exceed the total capacity of the electrical infrastructure of the data center when the power supply system in the electrical infrastructure of the data center is unavailable.

14. The method of claim 10, wherein:
the power management commands comprise power capping commands that limit how much power affected servers are permitted to consume; and
different power capping limits are applied to different servers based on relative priority of the different servers.

15. The method of claim 10, wherein:
the power management commands comprise shutdown commands that cause one or more servers to be shut down; and
an order in which different servers are shut down is based on relative priority of the different servers.

16. A method for facilitating increased utilization of a data center, comprising:
receiving power management commands for a plurality of servers in a data center, wherein the power management commands are received from a power management service, wherein the power management service sends the power management commands in response to an entity detecting that power consumption of servers in the data center exceeds a reduced total capacity of an electrical infrastructure of the data center; and
performing power management with respect to at least some of the plurality of servers based on the power management commands.

17. The method of claim 16, wherein:
the plurality of servers are included in a server rack;
the method is implemented by a server rack manager; and
the entity that detects that the power consumption of the servers in the data center exceeds the reduced total capacity comprises another service that is distinct from the power management service and from the server rack manager.

18. The method of claim 16, wherein:
the power management commands comprise power capping commands;
the method further comprises applying power capping limits to the set of servers based on the power capping commands; and
different power capping limits are applied to different servers based on relative priority of the different servers.

19. The method of claim 16, wherein:
the power management commands comprise shutdown commands;
the method further comprises shutting down one or more servers based on the shutdown commands; and
an order in which different servers are shut down is based on relative priority of the different servers.

20. The method of claim 16, wherein:
the power management commands comprise shutdown commands;
the method further comprises shutting down one or more virtual machines based on the shutdown commands; and
an order in which different virtual machines are shut down is based on relative priority of the different virtual machines.
